(19) United States
(12) Patent Application Publication
(10) Pub. No.: US 2022/0277252 A1
(43) Pub. Date: Sep. 1, 2022

(54) CASINO MANAGEMENT SYSTEM AND METHOD OF MANAGING AND EVALUATING CASINO STAFF

(71) Applicant: Paolo Adriano SERAFINA, Booragoon (AU)

(72) Inventor: Paolo Adriano SERAFINA, Booragoon (AU)

(21) Appl. No.: 17/612,714

(22) PCT Filed: May 21, 2020
(86) PCT No.: PCT/AU2020/050496

§ 371 Date: Nov. 19, 2021

(30) Foreign Application Priority Data
May 21, 2019 (AU) 2019 901718

(51) Int. Cl. G06Q 10/06; G06Q 10/10

(52) U.S. Cl. CPC G06Q 10/06398; G06Q 10/06395; G06Q 10/06393; G06Q 10/105

(57) ABSTRACT

Provided is a casino or gaming establishment arrangement 8 having at least one work site 9 and which includes a management system 10 which is configured to manage and evaluate a staff member. Evaluation of the staff member is achieved through the collection of several performance parameters at work sites 9, which are analysed and condensed into an efficiency score and a log of performance parameters. The efficiency score is a number that summarises the overall performance of the staff members, whereas the log of performance parameters is a detailed record of data, events, and occurrences that are assessed to provide an indication of performance. Management of the staff member is influenced by the information provided by a staff member profile.

### TECHNICAL FIELD

This disclosure broadly relates to the field of gaming and gambling, and more specifically to a casino system and method of managing staff. In particular, a casino arrangement and method of managing and evaluating casino service staff.

### BACKGROUND ART

The following discussion of the background art is intended to facilitate an understanding of the present disclosure only. The discussion is not an acknowledgement or admission that any of the material referred to is or was part of the common general knowledge as at the priority date of the application.

The gaming industry generates revenue through the entertainment of guests by the provision of services. The guests are predominantly occupied by gambling related services, such as poker, black jack and roulette. However, other support services, such as food and beverage, may be offered and provide further value to the guests. Although gambling related services and support services may be conceptionally different from each other, each service requires the employment of service staff by a gaming establishment to provide the services for enjoyment by guests.

The quality of services provided by the service staff will affect the satisfaction of the guests. This in turn will affect the generation of revenue for the gaming establishment. A poor service experience will lead to guest dissatisfaction, which in turn leads to decrease spending and patronage. As such, it is imperative that the service staff are sufficiently trained and incentivised to provide excellent customer service. To gauge the level of training and incentivisation required for each service staff member, it is important to monitor and evaluate their performance level.

A typical method of monitoring and evaluation performance level of service staff is performance appraisal conducted by an internal audit team. The internal audit team will monitor key performance indicators, such as in the example of a croupier, hand rate, errors and compliance issues. This is expensive, time consuming and limited in its behaviour modifying or morale boosting capabilities. Additionally, it does not provide opportunities for harvesting statistical information that allow for pattern analysis and dealer specific information to be viewed by management and the individual service staff member for training and development purposes in order to increase such key performance indicators.

The Applicant has identified a need in the art for a management system and method of managing service staff that provides an automated process for monitoring and evaluating the performance of service staff. Accordingly, the results of monitoring and evaluation may be harvested for optimisation of service staff performance. The present invention was conceived with this goal in mind.

### SUMMARY OF THE INVENTION

It is to be appreciated that reference herein to a ‘casino’ includes reference to any suitable gaming establishment. Similarly, reference herein to a ‘work site’ generally includes reference to a specific site or area managed by a particular staff member, e.g. a black jack table or roulette wheel to which a specific croupier is assigned to, a service area serviced by a particular host/hostess, etc.

According to a first aspect of the present invention there is provided a casino arrangement for managing and evaluating a staff member, said arrangement comprising at least one work site within a casino having a management system which comprises:

a server configured to:
generate and store a staff member profile, said staff member profile including an efficiency score and a log of performance parameters;
determine one or more work sites for allocation to the staff member profile;
transmit a first communication containing the one or more work sites allocated to the staff member profile
receive a second communication containing a selected work site;
receive a plurality of performance parameters from the selected work site, wherein the plurality of performance parameters is aggregated in real time into a set of performance parameters which is added to the log of performance parameters; and
determine an efficiency modifier based upon the set of performance parameters, said efficiency modifier used to modify the efficiency score of the staff member profile; and
   a staff device configured to:
retrieve the staff member profile and associate the staff member profile to the staff device;
receive and display the first communication on a display of the staff device;
receive input from the staff member, associated with the staff member profile, to select the allocated work site from the one or more work sites;
transmit the second communication containing the selected work site; and
receive and display the efficiency score on the staff device display, said efficiency score updated upon modification by the server.

In an embodiment, the arrangement includes a sensor configured to monitor the work site, said sensor configured to sense at least one performance parameter.

In an embodiment, the sensor is selected from a non-exhaustive group consisting of a camera, a card sensor, a movement sensor, a proximity sensor and a switch.

In an embodiment, the sensed performance parameter is selected from a non-exhaustive group consisting of a card presence, a person presence, a number of players participating at a work site, a croupier hand rate, croupier accuracy, croupier speed, and gaming wins/losses.

In an embodiment, the staff device includes the sensor.

In an embodiment, the staff device includes a payment terminal configured to accept payment from players.

In an embodiment, the payment terminal is configured to accept non-fiat payment, such as reward points, and to directly assign a value of such payment to a player for use at a work site.

In an embodiment, the management system is further configured to determine the efficiency modifier in real time or near real time in response to the aggregation of the set of performance parameters.

In an embodiment, the server is further configured to determine the one or more work sites for allocation to the staff member profile based upon a comparison of the log of performance parameters to a work site criterion for each of the one or more work sites.

In an embodiment, the management system further comprises:

the server being further configured to determine a reward based upon the efficiency score, said reward being allocated to the staff member profile; and

the staff device being further configured to receive and display, on the staff device graphics display, the reward allocated to the staff member profile.

In an embodiment, the management system further comprises:

the server being further configured to:
store a set of training multimedia material;
allocate the set of training multimedia material to the staff member profile, wherein the set of training multimedia material is allocated if the efficiency score is below a predetermined threshold;

the staff device is further configured to:
receive and deliver the set of training multimedia material using one or more multimedia outputs of the staff device.

In an embodiment, the server is further configured to:

determine a set of work site performance parameters based upon the set of performance parameters associated with the staff member profile;

determine a work site efficiency score, based upon the set of work site performance parameters; and

issue a closure of the selected work site, wherein the selected work site is no longer available for allocation.

In an embodiment, the server is further configured to:

determine another one or more work sites for allocation to the staff member profile;

transmit a fourth communication containing the closure for the selected work site and the another one or more work sites allocated to the staff member profile; and

receive a fifth communication containing a close time of the selected work site and a new selected work site.

In an embodiment, the server is further configured to:

receive an incident alert associated with the staff member profile;

generate an incident report comprising an incident log including the selected work site, the staff member profile, and an incident start time;

determine a supervisor staff member to be allocated the incident report;

transmit a sixth communication, to a supervisor device, containing the incident report, the selected work site, and the staff member profile;

receive a set of incident parameters, generated at the selected work site, said set of incident parameters is added to the incident report;

receive a seventh communication, from the supervisor device, said seventh communication contains an incident close time; and

determine an incident performance score based upon the set of incident parameters, said incident performance score added to the set of performance parameters allocated to the staff member profile.

In an embodiment, the management system further comprises a management device configured to:

receive the staff member profile;

receive and display the set of performance parameters and the efficiency score on a management device graphics display; and

transmit a manual allocation of one or more work sites to the staff member profile.

In an embodiment, the management system further comprise an external device configured to receive and display the efficiency score on an external device graphics display.

In an embodiment, the external device is further configured to receive and deliver the set of training multimedia material using one or more multimedia outputs of the external device.

According to a second aspect of the invention there is provided a method of managing and evaluating a casino staff member, the method comprising:

generating and storing a staff member profile on a server, said staff member profile including an efficiency score and a log of performance parameters of the staff member;

determining, by the server, one or more work sites for allocating to the staff member profile;

receiving, by the server, a plurality of performance parameters from the selected work site, wherein the plurality of performance parameters is aggregating in real time into a set of performance parameters, and the set of performance parameters is added to the log of performance parameters;

determining, by the server, an efficiency modifier based upon the set of performance parameters, wherein the efficiency modifier is being used to modify the efficiency score of the staff member profile;

displaying the efficiency score on a staff device graphics display, said efficiency score updated upon modification by the server.

In an embodiment, the step of receiving performance parameters comprises receiving such parameters from a sensor configured to monitor the work site, said sensor selected from a non-exhaustive group consisting of a camera, a card sensor, a movement sensor, a proximity sensor and a switch.

In an embodiment, determining the efficiency modifier is in real time or near real time in response to the aggregating of the set of performance parameters.

In an embodiment, determining one or more work sites for allocating to the staff member is based upon comparing the log of performance parameters to a work site criterion for each of the one or more work sites.

In an embodiment, the method further comprises allocating, by the server, a reward to the staff member, wherein the reward is allocated to the staff member profiled based upon the efficiency score.

In an embodiment, the method further comprises allocating, by the server, a set of training multimedia material to the staff member, wherein the set of training multimedia material is allocated to the staff member profile if the efficiency score is below a predetermined threshold.

In an embodiment, the method further comprises:

determining, by the server, a set of work site performance parameters based upon the set of performance parameters associated with the staff member profile;

determining, by the server, a work site efficiency score, based upon the set of work site performance parameters; and

issuing, by the server, a closure of the selected work site, wherein the selected work site is no longer available for allocation.

In an embodiment, the method further comprises allocating, by the server, another one or more work sites to the staff member profile after the closure of the selected work site.

According to a third aspect of the invention there is provided a computer programme comprising at least one instruction for controlling a computer system to implement the method in accordance with the second aspect of the invention above.

According to a fourth aspect of the invention there is provided a computer readable medium providing a computer programme in accordance with the third aspect of the invention above.

### BRIEF DESCRIPTION OF THE DRAWINGS

The description will be made with reference to the accompanying drawings in which:

FIG. 1 illustrates an example system embodying the present invention;

FIG. 2 is a flowchart of a method of managing and evaluating a staff member;

FIG. 3 illustrates an example representation of information displaying a staff member's performance on a staff device;

FIG. 4 illustrates an example representation of information displaying a team's performance on a staff device;

FIG. 5 is a flowchart of a method of determining a closure of a selected work site; and

FIG. 6 is a flowchart of a method of determining an incident performance score for an incident alert associated with the staff member.

### DETAILED DESCRIPTION OF EMBODIMENTS

Further features of the present invention are more fully described in the following description of several non-limiting embodiments thereof. This description is included solely for the purposes of exemplifying the present disclosure to the skilled addressee. It should not be understood as a restriction of the broad summary, disclosure or description of the invention as set out above. In the figures, incorporated to illustrate features of the example embodiment or embodiments, like reference numerals are used to identify like parts throughout.

The present disclosure broadly describes a casino or gaming establishment arrangement 8 having at least one work site 9 and which includes a management system 10 which is configured to manage and evaluate a staff member. Evaluation of the staff member is achieved through the collection of several performance parameters at work sites 9, which is analysed and condensed into an efficiency score and a log of performance parameters. The efficiency score is a number that summarises the overall performance of the staff members, whereas the log of performance parameters is a detailed record of data, events, and occurrences that are assessed to provide an indication of performance. Management of the staff member is influenced by the information provided by the staff member profile. Allocation of work sites 9 will be based upon the efficiency score and information provided in the log of performance parameters of the staff member. Additionally, the management system can manage the performance of the staff member using incentives and training material. In an example, the management system has determined that efficiency score of the staff member is high enough to warrant a financial reward in the form of a bonus. In another example, the management system has determined that the efficiency score of the staff member is too low and allocates a set of training videos to improve the competency of the staff member.

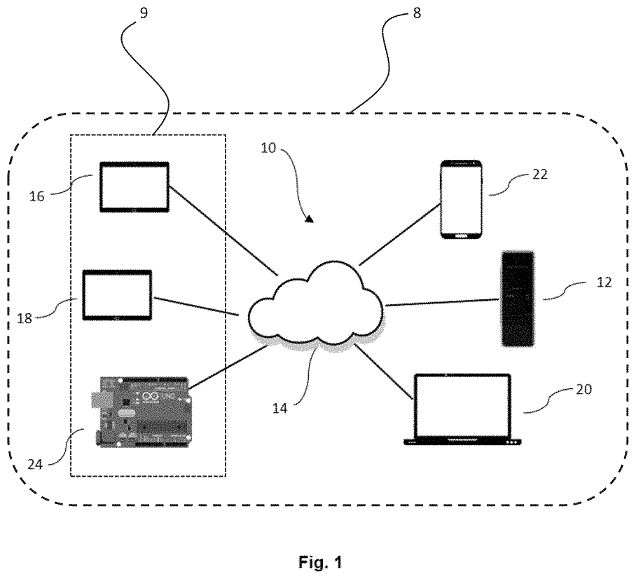

FIG. 1 illustrates the management system 10 according to an embodiment of the disclosure. The system 10 comprises a server 12 which is in communication with several devices through a network 14. The devices are typically a staff device 16, a supervisor device 18, a management device 20, and an external device 22. As will be apparent, each of the devices 16, 18, 20, and 22 can be any form of computing device, such as a smart phone, a tablet computer, a desktop computer or the like. The server 12 can be any form of computing device, preferably one with more processing power than the devices 16, 18, 20, and 22. Additionally, the server 12 is typically in communication with a plurality of data inputs 24, such as sensor(s) located at one or more work sites. These data inputs 24 may comprise radio frequency identification readers, video cameras, and video analysis software, as well as specific sensors. Additionally, data inputs 24 may include information imported from a guest device, such as digital feedback relating to the staff member who is manning a game table, or the like.

In an embodiment, the arrangement 8 includes a sensor 24 which is configured to monitor the work site 9, said sensor 24 configured to sense at least one performance parameter. The sensor 24 may include a camera, a card sensor, a movement sensor, a proximity sensor and/or a switch, or the like. Similarly, the sensed performance parameter may include a card presence, a person presence, a number of players participating at a work site, a croupier hand rate, croupier accuracy, croupier speed, and gaming wins/losses. In an embodiment, the staff device 16 includes the sensor 24.

The devices 16, 18, 20, and 22 are configured to be accessed by suitable staff members using typical login processes for retrieving their staff member profile and subsequently associating their staff member profile to the device. In an example, the staff device 16 is allocated to the staff member at the start of a work shift. The staff member would activate the staff device 16, retrieve their staff member profile and associate their staff member profile to the staff device. In another example, the supervisor device 18 is allocated to the supervisor at the start of a work shift. The supervisor would activate the supervisor device 18, retrieve their staff member profile and associate their staff member profile to the staff device.

In an embodiment, the staff device 16 includes a payment terminal configured to accept payment from players. For example, the payment terminal may be configured to accept fiat or non-fiat payment, such as reward points, and to directly assign a value of such payment to a player for use at a work site, or the like.

The server 12 is comprised of suitable components for communicating with multiple devices, retrieving and storing data, executing algorithms for analysing several performance parameters and determining efficiency scores, managing work site allocations to staff members, evaluating staff members, and other such computationally heavy workloads. The components are comprised of a computer processing unit, read only memory, random access memory, a storage device such as a hard disk drive, input/output devices such as a USB port, a graphics display such as a liquid crystal display, and a network interface such as an ethernet port.

The network interface of the server 12 is for communication with one or more computer networks 14. The network 14 may be a wired network, such as a wired Ethernet network, or a wireless network, such as a Bluetooth network. Additionally, the network 12 may be a local area network, such as a home office computer network, or a wide area network, such as the internet.

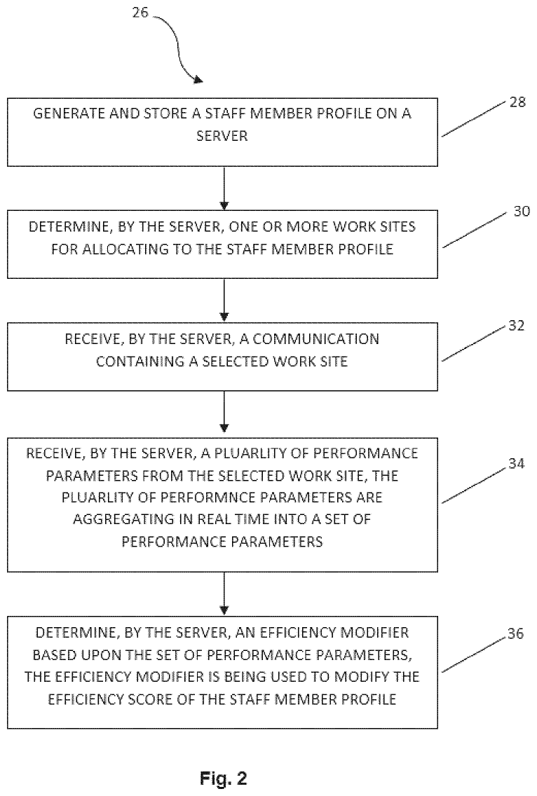

The server 12 is configured to perform a method of managing and evaluating a staff member 26, as shown in FIG. 2, according to a computer programme comprising at least on instruction for controlling the computer system to implement the method. The computer programme may be loaded into the storage device from a computer readable medium using the input/output device or from the network using the network interface.

At step 28, the server 12 is configured to generate and store a staff member profile, said staff member profile including an efficiency score and a log of performance parameters. At step 30, generation of the staff member profile may be conducted using one of the devices in communication with the network 14 prior to storage. In an example, the staff member uses the staff member device 16 to input details to generate the staff member profile. In another example, a management staff member uses the management device 20 to generate the staff member profile of a new hire that has yet to commence work.

At step 30, an allocation algorithm for pairing the staff member with suitable work sites is implemented on the server 12. The server 12 determines one or more work sites for allocation to the staff member profile based upon the information found in the staff member profile. The server 12 is configured to determine the suitability of one or more work site for allocation to the staff member profile based upon a comparison of the log of performance parameters to a work site criterion for each of the one or more work sites. In an example, the staff member profile contains information in the log of performance parameters showing that the staff member is unable to successfully manage a roulette table. As such, the allocation algorithm on the server 12 would disallow the allocation of work sites related to roulette tables.

For example, not all staff members are able to perform all tasks and the system needs to determine best-fit on multiple levels to assign a particular staff member to a specific area. Break-times, skill set, performance (which must also take into consideration the size of the game at the table (inputted into the system via sensor and or staff member/s) and time and day of the week which factors in the average value of a table and the best-fit staff member, given performance history, to that table. For example, a very busy $25 blackjack table is much more valuable than a $5 blackjack table that has only 1 player. The system will allocate the best-fit staff member to that table based on the information it generates and holds on each staff member.

Allocation of tasks and work sites are communicated using the network interface of the server 12. The server 12 utilises the network interface to transmit a first communication containing the one or more work sites allocated to the staff member profile. The staff device 16 receives and displays the first communication on a staff device graphics display in order to relay the information to the staff member. The staff device 16 is configured to receive input from the staff member, to select a selected work site from the one or more work sites. It would be appreciated by the person skilled in the art, that the means in which input is received by the staff member may be in any form typical to the device. In an example, the input may be a touch screen. In another example, the input may be a physical keyboard that forms part of the staff device 16.

At step 32, the selected work site is received by the server 12 through the transmission of a second communication, by the staff device 16, that contains the selected work site.

Evaluation of the staff member is conducted through the accumulation of a plurality of performance parameters from the selected work site. The plurality of performance parameters is accumulated using the plurality of data inputs 24, such as sensors, located at the selected work site. These data inputs 24 comprise of data loggers, sensors and database of accumulated information. In an example, the data inputs 24 includes the data loggers located at a gaming table that records information such as head counts, hand rates, and the amount of money exchanged for chips. In another example, the data inputs 24 include the database containing written feedback from guests and other staff members who work alongside the staff member. In a further example, the data inputs 24 include a radio-frequency identification reader and/or near field communication reader inbuilt into the staff device 16, which is used to record contact less payments from guests using contactless payment cards and/or computerised devices such as phones.

For example, data inputs 24 may include supervisory staff using their supervisor device (inspector terminal, table games manager terminal, surveillance application, or other remote device access terminal from other supervisory staff, even offsite in some cases) to make notes on staff and enter score modifying observations. For example, a pre-populated list of behaviours may be selectable by an inspector on a supervisor device who notices a behaviour or performance issue which will have either a negative or positive impact on a dealer's score as it can be attributed to that specific staff member.

Similarly, a staff device may also be configured to receive staff member (and work site) specific feedback. This information also feeds into the performance scores for staff. This has the additional benefit of increasing customer engagement and generates typically expensive to obtain data from customer experiences. For example, not only could this data come ad hoc from customers but surveys may be pushed to customers through a customer portal and reward them for answering survey questions with points they can use on site (described below).

At step 34, the plurality of data inputs 24 typically transmit their collected information to the server 12 through the network 14 for analysis by an evaluation algorithm. The server 12 receives the plurality of performance parameters from the selected work site and the evaluation algorithm subsequently aggregates the plurality of performance parameters in real time into a set of performance parameters. The set of performance parameters are added to the log of performance parameters of the staff member profile. The set of performance parameters are in the form of numeric values representative of positive or negative performance. In an example, negative feedback from guests and other staff members would be recorded as negative numeric values. In another example, a high hand rate would be recorded as a positive numeric value. In both examples, the greater the numeric value, both negative or positive, will indicate the significance of the result.

At step 36, the server 12 further determines an efficiency modifier, based upon the set of performance parameters, using the evaluation algorithm. The efficiency modifier is subsequently used to modify the efficiency score of the staff member profile to indicate progress of the staff member after finishing a shift at the selected work site. In an example, the staff member performed well at the selected work site, producing a high hand rate, issues many membership cards, and assisted other staff members in resolving issues. As the set of performance parameters would be in the form of positive values, indicating improvements in efficiency, the evaluation algorithm would determine a positive efficiency modifier. This positive efficiency modifier would modifier the efficiency score, indicating an improvement in performance. Additionally, the server 12 may be further configured to determine the efficiency modifier in real time or near real time in response to the aggregation of the set of performance parameters.

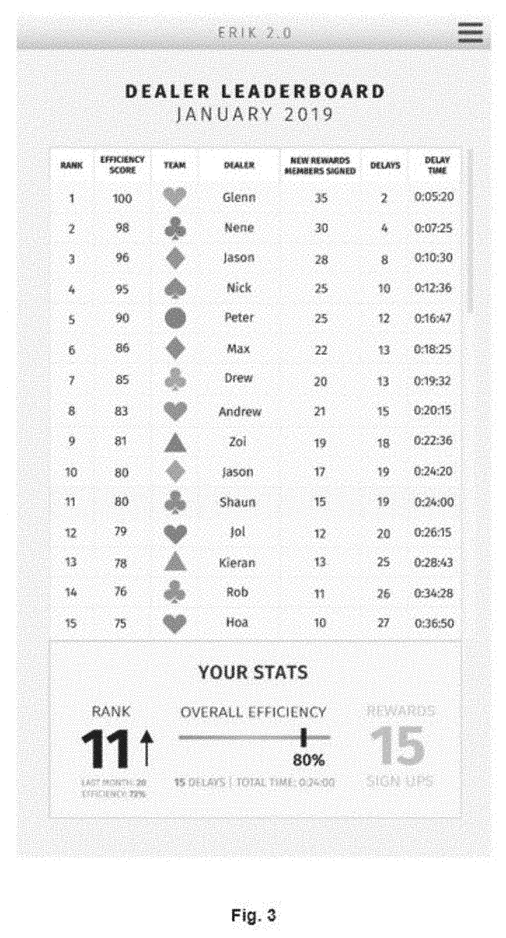

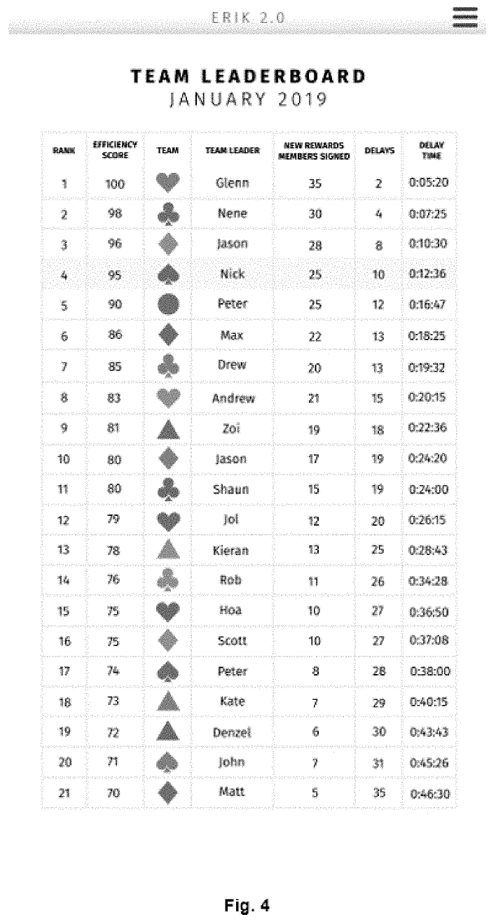

The staff device 16, being in constant communication with the server 12, will receive and display the efficiency score on the staff device graphics display as demonstrated in FIG. 3 or FIG. 4. Due to the constant flow of communication, the staff device graphics display will show the efficiency score being updated upon modification by the server 12. This provides the advantage of incentivising the staff member through psychological leveraging of human nature's desire for mastery, competition and achievement. This is illustrated in FIGS. 3 and 4, wherein the efficiency score is displayed on the staff device 16 as a leader board, wherein the staff member is being compared with the other staff members comprising the current staff member cohort. This allows for the staff members to compare themselves against their peers, providing intrinsic motivation through competition, participant motivation and engagement.

The efficiency score, being indicative of the performance of the staff member, may be utilised by the server 12 to determine whether the staff member should be rewarded or offered additional training. The server 12, using the evaluation algorithm, may be further configured to determine a reward for the staff member based upon the efficiency score. The reward may be a financial reward, in the form of a bonus, or another form of reward, such as an admission ticket to an event, reward points for use in a reward system, etc. In an example, the server 12 may allocate a minor reward to the staff member profile if the efficiency score is above a predetermined but a major reward if the efficiency score is of a higher predetermined value. To convey the reward to the staff member, the staff device 16 is further configured to receive and display, on the staff device graphics display, the reward allocated to the staff member profile. This provides the advantage of increasing the staff member's productivity through eliciting anticipation of pleasure by promising a potential reward for their efforts.

The reward may also comprise team-based parameters, which is something that generally increases motivation (psychologically), i.e. the idea of contributing to the team to which staff members are allocated (this allocation can also be based on the system's parameter gathering in the initial application of the system to a set of staff members in order to create balance in the teams). For example, individual performance contributes to team performance, then further allowing management to see which teams are best performing (and by association) which team leaders are motivating their teams best -encouraging team leader engagement with staff at all levels. This data may also be used to rank individual staff members for the purpose of “best dealer” type awards, or the like.

To improve competency of an underperforming staff member, the server 12 may allocate training material to the staff member profile. The server is configured to store a set of educational multimedia material, which is allocated to the staff member profile if the efficiency score of the staff member profile is below a predetermined threshold. The set of educational multimedia material is in a format that may be received by the staff device 16 and delivered using one or more multimedia outputs of the staff device 16. Additionally, the educational multimedia material may be stored upon the staff device 16 for later playback without having to repetitively access the server 12. Furthermore, the educational multimedia material may comprise educational material that is relevant to the staff member. In an example, the server 12 may determine that the staff member require further training relating to customer service mannerisms. The server 12 would subsequently allocate, to the staff member profile, educational multimedia material for improving customer service mannerisms.

It would be appreciated by the person skilled in the art that the staff member may seek to review their staff member profile outside of the workplace. This may be due to the staff member desiring to review their efficiency score, reward or access their training material outside of their place of employment. As such, the external device 22 may be configured, using a computer programme, to receive and display the efficiency score on an external device graphics display. Additionally, the external device 22 may be further configured to receive and deliver the set of educational multimedia material using one or more multimedia outputs. This provides the advantage of an off-duty staff member to review their work performance and improve their competency using the educational multimedia material. It also provides the psychological advantage of increasing productivity through self-directed learning and goal setting, and self-determination and responsibility.

It would be appreciated by the person skilled in the art that a management staff member is likely to monitor performance of the staff member during work at the selected work site. To enable this, the management device 20, which is in communication with the server 12 through the network 14, is configured to receive the staff member profile and the associated set of performance parameters and the efficiency score. This information is subsequently displayed on the management device graphics display for review by the management staff member. The management staff member may decide that the staff member requires reallocation to another work site and transmits a manual allocation of one or more work sites to the staff member profile.

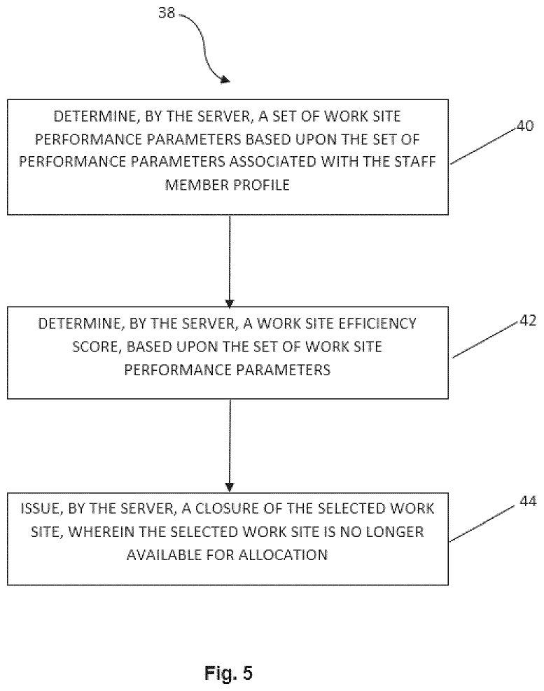

FIG. 5 illustrates an embodiment of the disclosure, wherein the server 12 may be configured to perform a method of determining a closure of the selected work site 38. Underperforming work sites or underutilised work sites may be closed to improve efficiency of staff member allocation and reduce costs of maintaining several work sites. Additionally, work sites may be closed to allow for the staff member to be reallocated to another work site or be allocated a break period. It is to be appreciated that the system autonomously tracks staff movement and table status and allocates breaks and movement orders without input, but while allowing input in emergency situations when required.

At step 40, the server 12, using a variant of the evaluation algorithm, is configured to determine a set of work site performance parameters based upon the set of performance parameters associated with the staff member profile. At step 42, a work site efficiency score is determined, based upon the set of work site performance parameters. If the work site efficiency score is below a predetermine value, the server 12 will issue a closure of the selected work site at step 44, wherein it will no longer be available for allocation to the staff member profile.

Additionally, if the staff member is still currently working at the selected work site which has a closure issued, the server may be further configured to reallocate the staff member. The server 12 may be further configured to determine another one or more work sites for allocation to the staff member profile. It will then transmit a fourth communication, containing the closure of the selected work site and the another one or more work sites allocated to the staff member profile. The information found in the further communication will be displayed on the staff device graphics display to inform the staff member. Subsequently, the staff member will input an acknowledgement of the closure of the selected work site and a selection of a new selected work site. This information will be communicated to the server 12 in the form of a fifth communication.

In another embodiment of the disclosure, the server 12 may be configured to determine whether the staff member is required to take a break according to health and safety regulations. The server 12, using a variant of the evaluation algorithm, is configured to determine a break allocation based upon the efficiency score of the staff member profile and/or a fixed interval value. If the efficiency score of the staff member profile reduces over a set amount of time or the fixed interval value has been surpassed, the server 12 will transmit a break allocation communication, containing the closure of the selected work site and an instruction to the staff member to take a break or to retire for the day.

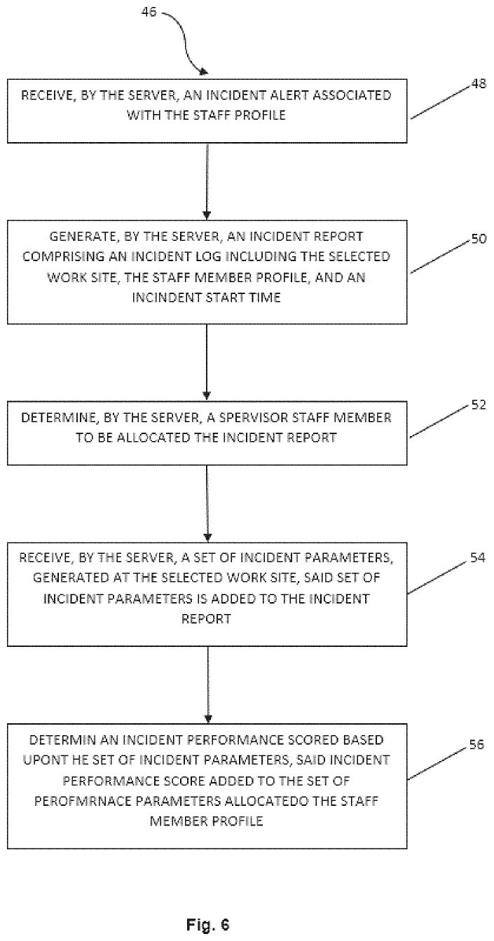

FIG. 6 illustrates another embodiment of the disclosure, wherein the server 12 may be further configured to perform a method of determining an incident performance score for an incident alert associated with the staff member 46. The incident may be something as simple as handling a guest complaint, to the resolution of a spot fire.

At step 48, the incident is initially reported as an incident alert by the staff member profile. At step 50, the server 12, upon receival of the incident alert, generates an incident report comprising and incident log that includes information such as the selected work site, the staff member profile who raised the incident alert, and an incident start time. At step 52, the server 12, using an incident algorithm, determines a suitable supervisor staff member to be allocated the incident report. Suitability will be based upon proximity to the incident, competency in resolving similar incidents, and compatibility with the staff member. The supervisor staff member is informed of the incident via the transmission of a sixth communication, to a supervisor staff device, containing the incident report, the selected work site and the staff member profile. During the resolution of the incident, at step 54 the plurality of data inputs 24 is recording a set of incident parameters, generated at the selected work site, and transmitting the data to the server 12. The server 12 subsequently determines an incident performance score, upon receiving a seventh communication containing an incident dose time, based upon the set of incident parameters. At step 56, the incident performance score is subsequently added to the set of performance parameters allocated to the staff member profile to provide evaluation of how the staff member handled the incident.

In this manner, an incident or issue with a table (to increase asset use or decrease downtime) or interdepartmental issue (like no drink service or requests for cleaning) can be dealt with while tracking those issues for remedy timeliness or downtime. This allows for table specific logs to be built around this data showing patterns specific to tables (for example a certain table may show higher than normal complaint numbers or has higher cleaning requests/requirements) as well as staff and any potential interconnected issues between tables and staff or staff and staff (for example and pattern emerging when certain staff members are in the same work area). In particular, maintenance requests can be pushed through here and patterns on this can show issues to be dealt with as a log will keep track of equipment or asset patterns. These issues are important as they not only have their own functional importance but they are necessary to build accurate efficiency score information about staff, i.e. staff cannot have their efficiency penalised for downtime if the reason for that downtime is a spilt drink on their table or an unruly player. This also increases inter-departmental communication as these incident logs will be available to all department supervisors, allowing pattern recognition and staff/area performance to be informed with additional stored data and tracked remedy timeliness.

It would be appreciated by a person skilled in the art, that the server 12, using the network 14, may service a plurality of devices 16, 18, 20, and 22. In an embodiment, the server 12 may be simultaneously managing and evaluating several staff devices 16 and several supervisor devices 18.

The following is a specific example of some performance parameters from a work site, particularly dealer or croupier efficiency score items:

Technical Issues (Hard Skills) may comprise:
1. Hand Rate (recorded by card sensor/hand completion button):
   a. Includes an adjustment for the impact of the headcount.
   b. Includes an adjustment for the impact of the game type.
   c. Includes an adjustment for the impact of the price point (table min).
2. Delays. Recorded/input initially on pad and detailed by supervisor to measure impact.
3. Errors. Recorded/input initially by camera or on pad and detailed by supervisor to measure impact.
4. Breach of Rules and Procedure Violations. Recorded by camera/surveillance/supervisor.
5. Open/Close Speed. Recorded by dealer and approved by supervisor.

Similarly, behaviour Issues (Soft Skills) may comprise:
1. Head Count. Input by dealer/supervisor on pad.
   a. Includes a headcount to carded play ratio.
2. Referrals (Rewards). Logged by supervisor or rewards staff.
3. Customer Feedback. Taken from customer devices using OR code on tables/POS or location services to attribute dealer, table and customer experience.
4. Punctuality. Measured by swipe dock and confirmed with pad
5. Inspector/TOM/CM Feedback. Made at Inspector pad and Manager terminal

Accordingly, in light of the above, dealer or croupier framework and score indicators may be weighted across the cumulative sum of the key indicators listed below hard and soft skills. The overall score should be ongoing and updated daily and should also consider a time factor ratio % if key indicators are not completed or for dealer error factoring, which would then adversely affect the score. Score should be calculated as per custom parameters set in system settings per venue. Below is an example to assist in total calculation scenario.

Hard Skills (H)=60% of total score
Soft Skills (5)=40% of total score

### Total Indicator=100%

The above key indicators should all be stored in the backend as configurable tuning parameters that can be maintained and modified in addition the below formula should be dynamic to allow other future key indicators to be added to the system if required, and the system should automatically re-calibrate and recalculate the new scores based on any new key indicators. For example, differing valuation of the skills based on the business rules of the organisation, e.g. hand rates/scan rates may be more valued and get increased weighting in Singapore casinos, whereas soft skills may be more heavily weighted in Vegas properties.

Current Score Formula−where uX is the users score as a decimal % value i.e 60%=(16) and the key indicator is also a decimal % value)

D(t)%=((H*uH)(S*uS))*100

Dealer score time factor on calculation which can also be configurable in admin module should be automated service that runs continuously so that when a user key parameter changes that could affect his/her score this is done in real time so that the score is always accurate as its updated each time a key indicator is updated with the user interaction.

Below are key parameters against each indicator listed above that they system should check for new data or use previous result if within the below time frame (tf) threshold these should also be linked to the indicators and configurable as properties of the key indicators in the admin module.

| Hard Skill Breakdown | |
|---|---|
| Hands Per Hour | 0.3 |
| Table Uptime | 0.3 |
| Open/Close Time | 0.3 |
| Dealer Errors | 0.05 |
| Breach of Rules | 0.05 |
| | 1.00 |

| Soft Skill Breakdown | |
|---|---|
| Average Head Count | 0.25 |
| Head to Card Ratio | 0.25 |
| Customer Feedback | 0.25 |
| Insp/TGM Feedback | 0.1 |
| Rewards Referrals | 0.1 |
| Punctuality | 0.05 |
| | 1.00 |

Score v1 assigns a weighting (to be decided by a player) to each hard and soft skill. For skills were an average can be used in that skill, the score is a percentage of the average multiplied by the weighting. In this situation a perfectly average dealer will get a score of 0.84 (840), in a 60-40 skill split.

Timescale (TSI) factorising (should be in days or a consistent type across all)
TSD=30 days (i=D=Dealer error parameter)
TSR=90 days (I=R=Hard skill parameter)
TSM=90 days (I=M=Soft Skill parameter)

Penalty indicator formula: can be applied in case where a result is not found for the user and a previous result needs to be used will be sliding scale so once the TS factor is reached the weighted value should=0 for that indicator if no further input from user.

PI(x)=x/TSi×PiV (previous indicator value)

### New Indicator Score=PiV−PI(x)

| Category and overall test Scale | Min | Max | Status |
|---|---|---|---|
| Increased by 3-4 | 3 | 4 | 1 Green up arrow |
| Increased by 5-6 | 5 | 6 | 2 Green up arrows |
| Increased by 7+ | 7 | 7+ | 3 Green up arrows |
| Unchanged | | | 1 Yellow up arrow |
| Increased by 1 | 1 | 1 | 2 Yellow up arrows |
| Increased by 2 | 2 | 2 | 3 Yellow up arrows |
| Decreased by 1 | −1 | −1 | 1 Yellow down arrow |
| Decreased by 2 | −2 | −2 | 2 Yellow down arrows |
| Decreased by 3-4 | −3 | −4 | 1 Red down arrow |
| Decreased by 5-6 | −5 | −6 | 2 Red down arrow |
| Decreased by 7+ | −7 | −7+ | 3 Red down arrows |

The skilled addressee is to appreciate that, while the present invention has been described with reference to a casino or gaming establishment, the arrangements and methods described herein may also be applied to other work sites where staff performance is measurable, such as a supermarket, a restaurant, a factory, etc. Accordingly, the examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor expects skilled artisans to employ such variations as appropriate, and the inventor(s) intends for the claimed subject matter to be practiced other than as specifically described herein.

It is to be appreciated that reference to “one example” or “an example” of the disclosure, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Any method steps, processes, and operations described herein are not to be construed as necessarily requiring their performance in the particular order discussed or illustrated, unless specifically identified as an order of performance. It is also to be understood that additional or alternative steps may be employed.

1. A casino arrangement for managing and evaluating a staff member, said arrangement comprising at least one work site within a casino having a management system which comprises:
a server configured to:
generate and store a staff member profile, said staff member profile including an efficiency score and a log of performance parameters;
determine one or more work sites for allocation to the staff member profile;
transmit a first communication that identifies the one or more work sites allocated to the staff member profile
receive a second communication that indicates a selected work site;
receive a plurality of performance parameters from the selected work site via respective data inputs indicative of staff technical performance and behavioural performance, wherein the plurality of performance parameters is aggregated in real time into a set of performance parameters which is added to the log of performance parameters; and
determine an efficiency modifier based upon the set of performance parameters, said efficiency modifier used to modify the efficiency score of the staff member profile;
wherein the aggregation of said performance parameters and determination of said efficiency modifier are performed via an evaluation algorithm accounting for said staff technical and behavioural performance data inputs over a predetermined time frame threshold; and
a staff device configured to:
retrieve the staff member profile from the server and associate the staff member profile to the staff device;
receive and display the first communication on a display of the staff device;
receive input from the staff member, associated with the staff member profile, that identifies a selected work site from the one or more work sites allocated to the staff member;
transmit the second communication that identifies the selected work site; and
receive and display the efficiency score on the staff device display, said efficiency score updated upon modification by the server.

2. The arrangement of claim 1, which includes a sensor configured to monitor the work site, said sensor configured to sense at least one performance parameter.

3. The arrangement of claim 2, wherein the sensor is selected from a non-exhaustive group consisting of a camera, a card sensor, a movement sensor, a proximity sensor and a switch.

4. The arrangement of claim 2, wherein the sensed performance parameter is selected from a non-exhaustive group consisting of a card presence, a person presence, a number of players participating at a work site, a croupier hand rate, croupier accuracy, croupier speed, and gaming wins/losses.

5. The arrangement of claim 2, wherein the staff device includes the sensor.

6. The arrangement of claim 1, wherein the staff device includes a payment terminal configured to accept payment from players.

7. The arrangement of claim 6, wherein the payment terminal is configured to accept a non-fiat payment, and to directly assign a value of the non-fiat payment to a player for use at a work site.

8. The arrangement of claim 1, wherein the management system is further configured to determine the efficiency modifier in at least near real time in response to the aggregation of the set of performance parameters.

9. The arrangement of claim 1, wherein the server is further configured to determine the one or more work sites for allocation to the staff member profile based upon a comparison of the log of performance parameters to a work site criterion for each of the one or more work sites.

10. The arrangement of claim 1, wherein the management system further comprises:
the server being further configured to determine a reward based upon the efficiency score, said reward being allocated to the staff member profile; and
the staff device being further configured to receive and display, on the staff device graphics display, information corresponding to the reward allocated to the staff member profile.

11. The arrangement of claim 1, wherein the management system further comprises the server being further configured to:
store a set of training multimedia material;
allocate the set of training multimedia material to the staff member profile, wherein the set of training multimedia material is allocated if the efficiency score is below a predetermined threshold;
the staff device is further configured to:
receive and deliver the set of training multimedia material using one or more multimedia outputs of the staff device.

12. The arrangement of claim 1, wherein the server is further configured to:
determine a set of work site performance parameters based upon the set of performance parameters associated with the staff member profile;
determine a work site efficiency score, based upon the set of work site performance parameters; and
issue a closure of the selected work site, wherein the selected work site is no longer available for allocation in response to the issuance of the closure.

13. The arrangement of claim 12, wherein the server is further configured to:
determine another one or more work sites for allocation to the staff member profile;
transmit a third communication indicating the closure for the selected work site and identifying another one or more work sites allocated to the staff member profile; and
receive a fourth communication indicating a close time of the selected work site and a new selected work site.

14. The arrangement of claim 1, wherein the server is further configured to:
receive an incident alert associated with the staff member profile;
generate an incident report comprising an incident log including the selected work site, the staff member profile, and an incident start time;
determine a supervisor staff member to be allocated the incident report;
transmit a third communication, to a supervisor device, information pertaining to the incident report, the selected work site, and the staff member profile;
receive a set of incident parameters, generated at the selected work site, said set of incident parameters is added to the incident report;
receive a fourth communication, from the supervisor device, said fourth communication indicates an incident close time; and
determine an incident performance score based upon the set of incident parameters, said incident performance score added to the set of performance parameters allocated to the staff member profile.

15. The arrangement of claim 1, wherein the management system further comprises a management device configured to:
receive the staff member profile;
receive and display the set of performance parameters and the efficiency score on a management device graphics display; and
transmit a manual allocation of one or more work sites to the staff member profile.

16. The arrangement of claim 1, wherein the management system further comprise an external device configured to receive and display the efficiency score on an external device graphics display.

17. The arrangement of claim 16, wherein the external device is further configured to receive and deliver the set of training multimedia material using one or more multimedia outputs of the external device.

18. A method of managing and evaluating a casino staff member, the method comprising:
generating and storing a staff member profile on a server, said staff member profile including an efficiency score and a log of performance parameters of the staff member;
determining, by the server, one or more work sites for allocating to the staff member profile;
receiving, by the server, a plurality of performance parameters from the selected work site via respective data inputs indicative of staff technical performance and behavioural performance, wherein the plurality of performance parameters is aggregated in real time into a set of performance parameters, and the set of performance parameters is added to the log of performance parameters;
determining, by the server, an efficiency modifier based upon the set of performance parameters, wherein the efficiency modifier is being used to modify the efficiency score of the staff member profile, the aggregation of said performance parameters and determination of said efficiency modifier performed via an evaluation algorithm accounting for said staff technical performance data inputs and behavioural performance data inputs over a predetermined time frame threshold;
displaying the efficiency score on a staff device graphics display, said efficiency score updated upon modification by the server.

19. The method of claim 18, wherein the step of receiving performance parameters comprises receiving such parameters from a sensor configured to monitor the work site, said sensor selected from a non-exhaustive group consisting of a camera, a card sensor, a movement sensor, a proximity sensor and a switch.

20. The method of claim 18, wherein determining the efficiency modifier is in at least near real time in response to the aggregating of the set of performance parameters.

21.-27. (canceled)
